(19) United States
(12) Patent Application Publication
(10) Pub. No.: US 2008/0237429 A1
(43) Pub. Date: Oct. 2, 2008

(54) IMAGE INPUT/OUTPUT APPARATUS WITH FREE STOP FUNCTION AND OFFSET SLIDER CRANK MECHANISM THEREWITH

(76) Inventors: Chern-Shi Lam, Batu Pahat (MY); Yen-Sung Hsieh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/868,968

(22) Filed: Oct. 9, 2007

(30) Foreign Application Priority Data
Mar. 30, 2007 (TW) 096111474

(51) Int. Cl. F16M 13/02

(52) U.S. Cl. 248/351

(57) ABSTRACT

An offset slider crank mechanism is connected a main body and an open/closed body. The open/closed body is pivoted to the main body in a foldable manner. A slot is disposed on the main body. A width between a first end of the slot and a second end of the slot is increasing. The offset slider crank mechanism includes a crank. A first end of the crank is connected to the open/closed body in a rotatable manner. The offset slider crank mechanism further includes a slider connected to a second end of the crank and set inside the slot in a slidable manner. When the slider engages at the first end of the slot, the slider deforms at a first deformation. When the slider engages at the second end of the slot, the slider deforms at a second deformation. The first deformation is greater than the second deformation.

### BACKGROUND OF THE INVENTION

1. Field of the Invention

The present invention relates to an image input/output apparatus and an offset slider crank mechanism therewith, and more particularly, to an image input/output apparatus with free stop function and an offset slider crank mechanism therewith.

2. Description of the Prior Art

Multi-function products (MFPs) integrate various functions of typical functional machines together, such as printing, scanning, facsimile, and copy machines, so that both the cost of purchasing functional machines separately and the required storage space are reduced. MFPs have become mainstream in the market, with placement in schools, classrooms, family households, and studios, and are broadly used as an output device in today's information-oriented society. However an open/closed body of the multi-function product has to be lifted when operating some functions or replacing inner components. For example, a scan module of the multi-function product has to be lifted for a certain height so that a user can replace an ink cartridge inside the multi-function product. A support mechanism connected to the open/closed body and a main body is designed for fixing the open/closed body above the main body to prevent the open/closed body from falling so as to protect hands of the user.

For instance, U.S. Pat. No. 7,069,622 discloses a cam mechanism for the free stop and one-hand opening or closing functions. However the cam mechanism has disadvantages of high cost, complicated mechanical components, and utilizing more mechanical components. There is a need to find a support mechanism of opening or closing the open/closed body of the multi-function product with low cost, few and simple mechanical components, free stop function, and one-hand operation.

### SUMMARY OF THE INVENTION

It is therefore a primary objective of the claimed invention to provide an image input/output apparatus with free stop function and an offset slider crank mechanism therewith for solving the above-mentioned problem.

According to the claimed invention, an offset slider crank mechanism is connected a main body and an open/closed body. The open/closed body is pivoted to the main body in a foldable manner. A slot is disposed on the main body. The slot includes a first end and a second end. The width between the first end of the slot and the second end of the slot is increasing. The offset slider crank mechanism includes a crank. A first end of the crank is connected to the open/closed body in a rotatable manner. The offset slider crank mechanism further includes a slider connected to a second end of the crank and set inside the slot in a slidable manner. When the slider engages at the first end of the slot, the slider has at a first deformation. When the slider engages at the second end of the slot, the slider has at a second deformation. The first deformation is greater than the second deformation.

According to the claimed invention, an image input/output apparatus includes a main body, an open/closed body, and an offset slider crank mechanism. The offset slider crank mechanism is connected the main body and the open/closed body. The open/closed body is pivoted to the main body in a foldable manner. A slot is disposed on the main body. The slot includes a first end and a second end. The width between the first end of the slot and the second end of the slot is increasing. The offset slider crank mechanism includes a crank. A first end of the crank is connected to the open/closed body in a rotatable manner. The offset slider crank mechanism further includes a slider connected to a second end of the crank and set inside the slot in a slidable manner. When the slider engages at the first end of the slot, the slider has at a first deformation. When the slider engages at the second end of the slot, the slider has at a second deformation. The first deformation is greater than the second deformation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image input/output apparatus of the present invention.

FIG. 2 is a diagram of an open/closed body fixing in a first position relatively to a main body according to an embodiment of the present invention.

FIG. 3 is a diagram of the open/closed body fixing in a second position relatively to the main body according to the embodiment of the present invention.

FIG. 4 is a top view of a housing of the main body according to the embodiment of the present invention.

FIG. 5 is a top view of the housing of the main body according to another embodiment of the present invention.

### DETAILED DESCRIPTION

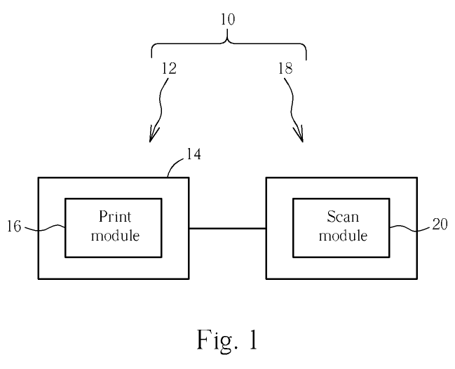

Please refer to FIG. 1 . FIG. 1 is a functional block diagram of an image input/output apparatus 10 of the present invention. The image input/output apparatus 10 can be a multi-function product. The image input/output apparatus 10 includes a main body 12 including a housing 14. The image input/output apparatus 10 further includes a print module 16 set inside the housing 14 of the main body 12 for printing image data as an image output interface of the image input/output apparatus 10. The image input/output apparatus 10 further includes an open/closed body 18 pivoted to the main body 12, and a scan module 20 set inside the open/closed body 18 for scanning image data as an image input interface of the image input/output apparatus 10. Besides, the print module 16 also can be set inside the open/closed body 18, and the scan module 20 can be set inside the main body 12. Functional machines with other functions also can be set inside the main body 12 and the open/closed body 18, such as a fax module, a copy module, and so on.

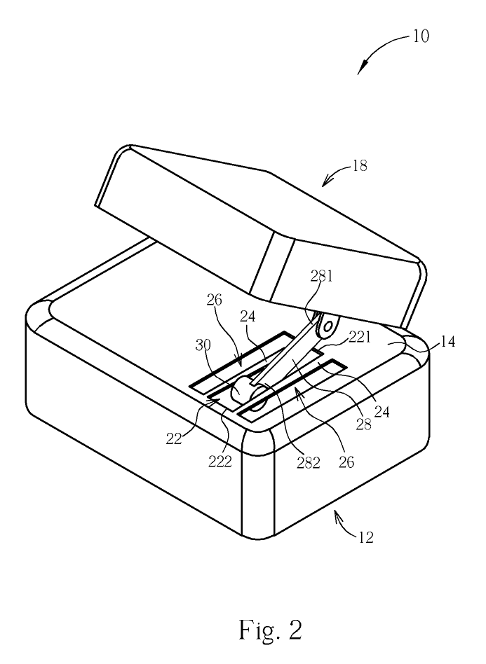

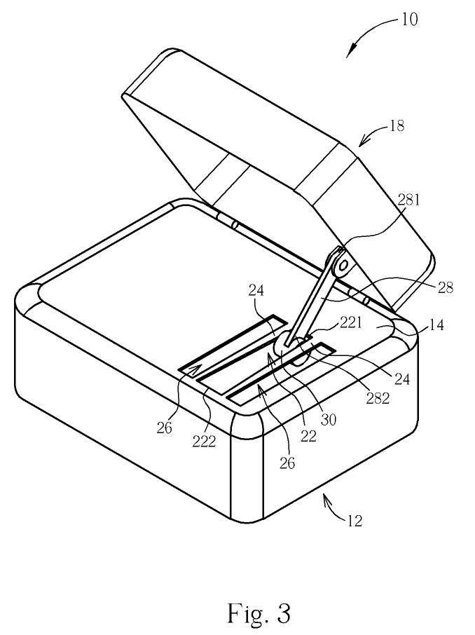

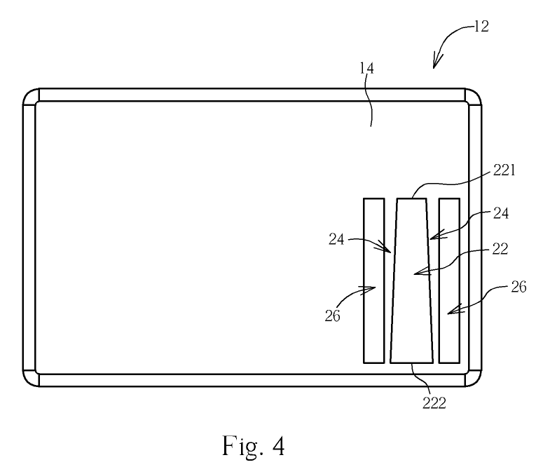

Please refer to FIG. 2 and FIG. 3. FIG. 2 is a diagram of the open/closed body 18 fixing in a first position relatively to the main body 12 according to an embodiment of the present invention. FIG. 3 is a diagram of the open/closed body 18 fixing in a second position relatively to the main body 12 according to the embodiment of the present invention. The open/closed body 18 is pivoted to the main body 12 in a foldable manner. A slot 22 is disposed on the housing 14 of the main body 12. The slot 22 includes a first end 221 and a second end 222. The width between the first end 221 of the slot 22 and the second end 222 of the slot 22 is increasing. Please refer to FIG. 4. FIG. 4 is a top view of the housing 14 of the main body 12 according to the embodiment of the present invention. The slot 22 can be a trapezoid slot. The trapezoid slot can be formed by two trapezoid tracks 24. A notch 26 is disposed on a side of each trapezoid track 24 for reducing the rigidity of the housing 14 so that the trapezoid tracks 24 can deform easily.

Please continue referring to FIG. 2 and FIG. 3. The image input/output apparatus 10 further includes an offset slider crank mechanism. The offset slider crank mechanism includes a crank 28. A first end 281 of the crank 28 is connected to the open/closed body 18 in a rotatable manner. The crank 28 can be pivoted to the open/closed body 18. The offset slider crank mechanism further includes a slider 30 connected to a second end 282 of the crank 28 and set inside the slot 22 in a slidable manner. The crank 28 and the slider 30 can be integrated in a monolithic structure, or the slider 30 can be pivoted to the crank 28. The slider 30 can be made of elastic material, such as plastic material. The rotary movement of the crank 28 relatively to the open/closed body 18 causes the linear movement of the slider 30 inside the slot 22. The slider 30 engages in the slot 22 of the housing 14 in a tight fit manner. A width of the slider 30 is greater than a width of each section of the slot 22. The slider 30 engages in the slot 22 of the housing 14 in a tight fit manner when the open/closed body 18 is fixed in any position relatively to the main body 12. That is, the slider 30 deforms at different deformations by the slot 22 when the slider 30 slides in the slot 22 with different sections on the slot 22 so as to hold the open/closed body 18 in different positions relatively to the main body 12. The slider 30 is made of elastic material so as to deform easily. The rigidity of the housing 14 is reduced because the notch 26 is formed on the side of the trapezoid track 24 so that the trapezoid track 24 can deform easily due to compression of the slider 30 and the slider 30 can slide in the slot 22 smoothly. When the user lifts the open/closed body 18 from the first position to the second position relatively to the main body 12, that is, the slider 30 slides from the second end 222 of the slot 22 to the first end 221 of the slot 22, a width of the section of the slot 22 which the slider 30 engages in decreases. The elastic deformation of the slider 30 increases from a first deformation to a second deformation. Different friction forces between the slider 30 and the housing 14 are generated when the open/closed body 18 is fixed in different positions. When the user lifts the open/closed body 18 from the first position to the second position relatively to the main body 12, the deformation of the slider 30 and the friction force between the slider 30 and the housing 14 increase. That is, it is easy to open the open/closed body 18 in the first position, and it is difficult to open the open/closed body 18 in the second position so that the slider 30 engages in the slot 22 tightly. Then the user can stretch out one's hand inside the main body 12 for replacing components inside the main body 12. In conclusion, the rotary movement of the open/closed body 18 relatively to the main body 12 drives the crank 28 to rotate, and the rotary movement of the crank 28 relatively to the open/closed body 18 causes the linear movement of the slider 30 inside the slot 22. The tight fit of the slider 30 and the slot 22 can fix the open/closed body 18 at any angle relatively to the main body 12 for the free stop function. Besides, the user can open or close the open/closed body 18 with one hand.

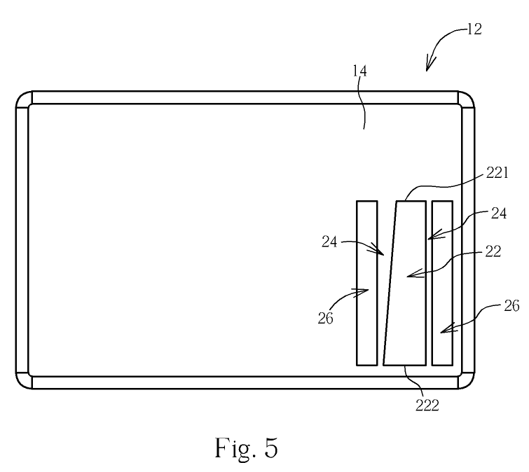

Please refer to FIG. 5. FIG. 5 is a top view of the housing 14 of the main body 12 according to another embodiment of the present invention. The trapezoid slot can be formed by only one trapezoid track 24. That is, a width of a side of the slot 22 from the first end 221 to the second side 22 increases, and a width of the other side of the slot 22 from the first end 221 to the second side 22 keeps constant. The whole width of the slot 22 from the first end 221 to the second side 22 still increases. The working principle of this embodiment is the same as the one of the above-mentioned embodiment, and the detailed description is omitted.

In contrast to the prior art, the present invention utilizes the offset slider crank mechanism as the support mechanism of the open/closed body above the main body. The rotary movement of the open/closed body relatively to the main body drives the crank to rotate, and the rotary movement of the crank relatively to the open/closed body causes the linear movement of the slider inside the slot. The tight fit of the slider and the slot can fix the open/closed body at any angle relatively to the main body for the free stop function. Besides, the user can open or close the open/closed body with one hand. The support mechanism of the image input/output apparatus of the present invention has advantages of low cost, few and simple mechanical components, free stop function, and one-hand operation for opening or closing the open/closed body.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An offset slider crank mechanism for connecting a main body and an open/closed body, the open/closed body being pivoted to the main body, a slot being disposed on the main body, the slot comprising a first end and a second end, and a width between the first end of the slot and the second end of the slot being increasing, the offset slider crank mechanism comprising:
a crank, a first end of the crank being connected to the open/closed body in a rotatable manner; and
a slider connected to a second end of the crank and set inside the slot in a slidable manner, the slider having a first deformation when the slider engages at the first end of the slot, the slider having a second deformation when the slider engages at the second end of the slot, and the first deformation being greater than the second deformation (“a first end connected to the open/closed body” has been described, so it had better describe “a slider connected to a second end”).

2. The offset slider crank mechanism of claim 1 wherein the slider is made of elastic material.

3. The offset slider crank mechanism of claim 1 wherein the crank is pivoted to the open/closed body.

4. The offset slider crank mechanism of claim 1 wherein a width of the slider is greater than the second end of the slot substantially.

5. An image input/output apparatus comprising:
a main body comprising a housing, a slot being disposed on the housing, the slot comprising a first end and a second end, and a width between the first end of the slot and the second end of the slot being increasing;
an open/closed body pivoted to the main body in a foldable manner; and
an offset slider crank mechanism comprising:
a crank, a first end of the crank being connected to the open/closed body in a rotatable manner; and
a slider connected to a second end of the crank and set inside the slot in a slidable manner, the slider having a first deformation when the slider engages at the first end of the slot, the slider having at a second deformation when the slider engages at the second end of the slot, and the first deformation being greater than the second deformation.

6. The image input/output apparatus of claim 5 wherein the slot is a trapezoid slot.

7. The image input/output apparatus of claim 6 wherein the housing of the main body comprises at least one trapezoid track for forming the trapezoid slot.

8. The image input/output apparatus of claim 7 wherein a notch is disposed on a side of the trapezoid track for reducing rigidity of the housing.

9. The image input/output apparatus of claim 5 wherein the slider is made of elastic material.

10. The image input/output apparatus of claim 5 wherein the crank is pivoted to the open/closed body.

11. The image input/output apparatus of claim 5 wherein a width of the slider is greater than the second end of the slot substantially.

12. The image input/output apparatus of claim 5 further comprising:
a scan module set inside the open/closed body; and
a print module set inside the housing of the main body.
